(19) United States
(12) Patent Application Publication
(10) Pub. No.: US 2005/0007912 A1
(43) Pub. Date: Jan. 13, 2005

(54) Recording medium, recording method and recording apparatus

(75) Inventors: Osamu Kawamae, Tokyo (JP); Taku Hoshizawa, Tokyo (JP)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignees: Hitachi, Ltd., Tokyo (JP); Hitachi-LG Data Storage, Inc., Tokyo (JP)

(21) Appl. No.: 10/816,162

(22) Filed: Mar. 31, 2004

(30) Foreign Application Priority Data
Jul. 7, 2003 (JP) 2003-192561
Jan. 9, 2004 (JP) 2004-003606

(51) Int. Cl. G11B 5/09

(52) U.S. Cl. 369/47.21; 369/53.24; 369/53.2; 369/59.23

(57) ABSTRACT

In an information recording method of recording data in a recording medium, information in a space bit map format representing recorded and unrecorded areas assigned according to each recording unit of the areas in the recording medium is recorded in the recording medium. When information corresponding to a position of recorded and unrecorded areas is updated, the information in the space bit map format is again recorded in the recording medium at predetermined timing.

### BACKGROUND OF THE INVENTION

The present invention relates to a method of controlling recorded and unrecorded (recorded/unrecorded) areas when data is written in a recording optical disk.

Optical disks have been broadly used as recording media to record data therein. When information is recorded in an optical disk or when a finalizing operation is conducted therein (when a recording operation is finished, a close session (fixing) is conducted with a specification to prevent addition of another session), it is required to determine whether or not a disk area to be used is a recorded area or an unrecorded area. Therefore, information to control the recorded and unrecorded areas is important. In this connection, JP-A-10-112166 describes in pages 4 and 5 ([0019] to [0030]) a method of creating a map of unrecorded blocks using a space bit map.

Particularly, since the writing operation can be only once allowed in each recordable area of a write-once optical disk such as a compact disk recordable (CD-R) and a digital versatile disk recordable (DVD-R), control of recorded and unrecorded areas is quite important.

Ordinarily, a write-once disk includes a recording film or layer produced on a substrate using organic pigment. When a laser beam is radiated onto the recording film, the film absorbs light and generates heat, and then plastic deformation takes place in the substrate. As a result, the deformed portion is reduced in the reflection factor as compared with the other portion not deformed. Paying attention to this phenomenon, information is read from the disk by using the difference in the reflection factor. Once a portion of the substrate is deformed due to the recording operation, the deformed state of the portion cannot be restored to the original state. That is, the recording operation can be allowed only once in each recordable area. In consequence, to use such a write-once disk, recorded areas and unrecorded areas are controlled so that a location in which a write data is to be recorded is appropriately determined before the data is recorded in the disk.

The recording capacity of the optical disk will become greater in the future and the larger amount of data will be recorded in the disk. Particularly, when the optical disk is used for a personal computer, files have various sizes and hence control of recorded areas becomes complicated. The JP-A-6-119127 described an idea in pages 2 and 3 ([0002] to [0006] and [0009]) in which when a system is powered or when a write-once optical disk is removed, a check is made for recorded areas and unrecorded areas in the disk. Results of the check are stored in a random access memory (RAM) such that after data is written in the optical disk, the contents of the RAM are updated according to a state of data written in the memory.

The optical disk has an advantage of random accessibility. That is, the user can access an area at any desired address in a random way. Even when a rule stipulating that data must be recorded in recording areas, for example, beginning at an inner circle of the disk is removed, the user can randomly access any recording area to record data therein. However, JP-A-10-112166 does describe any configuration to save control information of concrete areas. JP-A-6-119127 does not describe any configuration of control information of concrete areas.

When the disk capacity becomes greater, it is required to control quite a large number of areas. Therefore, a large storage capacity is necessary to store control information for the areas. Particularly, a recording media allowing only one recording operation for each recordable area is accompanied with a problem of wearing of a control area used to control recording areas. The control information is important and requires high reliability. Therefore, the readout speed and the reliability are influenced depending on the configuration of control information used to control the areas.

### SUMMARY OF THE INVENTION

To solve the problems, there is provided according to the present invention an information recording method of recording data in a recording medium including the steps of recording therein information corresponding to a position of recorded and unrecorded areas and the information is recorded again in the recording medium at predetermined timing.

According to the present invention, there is provided a recording apparatus including a pickup, a signal processing circuit to process signals in a recording operation, and an interface to conduct data input/output operations. Information corresponding to a position of recorded area and unrecorded areas is read from a recording medium, and information corresponding to a position of recorded area and unrecorded areas is stored in a nonvolatile memory. When the information corresponding to a position of recorded and unrecorded areas is updated, an update flag indicating the update is set in the nonvolatile memory. Information corresponding to the recorded areas is recorded in the recording medium at predetermined timing. When the recording operation is finished, the update flag is reset.

The pickup reads the information corresponding to a position of recorded and unrecorded areas from the recording medium. When the information corresponding to a position of the recorded and unrecorded areas is updated, error data is produced at a particular position to indicate the update.

When a small unrecorded area occurs, a flag indicating a recording direction helps easily detect such a small unrecorded area. By disposing a flag corresponding to timing to record information of a position of recorded areas, precision of the information of recorded and unrecorded areas is indicated.

Specific aspects of the present invention are as follows.

According to one aspect of the present invention, there is provided an information recording method of recording data in a recording medium including the steps of recording, in the recording medium, information in a space bit map format representing recorded and unrecorded areas assigned according to each recording unit of the areas in the recording medium, and recording, when information corresponding to a position of recorded and unrecorded areas is updated, the information in a space bit map format again in the recording medium at predetermined timing.

According to one aspect of the present invention, there is provided a recording apparatus for recording data in a recording medium including a pickup, a signal processing circuit for executing signal processing to record data in the recording medium, and an interface for conducting data input and output operations. The pickup reads, from the recording medium, information in a space bit map format representing recorded and unrecorded areas assigned according to each recording unit of the areas in the recording medium and then stores the information corresponding to a position of recorded and unrecorded areas in a nonvolatile memory.

According to one aspect of the present invention, there is provided a recording apparatus for recording data in a recording medium including a pickup, a signal processing circuit for executing signal processing to record data in the recording medium, and an interface for conducting data input and output operations. The pickup reads, from the recording medium, information in a space bit map format representing recorded and unrecorded areas assigned according to each recording unit of the areas in the recording medium. When the information in the space bit map format is updated, an error data is caused at a particular position indicating an event of update of the information.

According to one aspect of the present invention, there is provided an information recording method of recording data in a recording medium including the steps of recording, in the recording medium, information to control recorded and unrecorded areas in areas in the recording medium; recording, when the information to control recorded and unrecorded areas is updated, the information in the recording medium at predetermined timing; and recording one of flags indicating respective types of the timing of the update in the recording medium.

According to one aspect of the present invention, there is provided a recording apparatus for recording data in a recording medium including a pickup, a signal processing circuit for executing signal processing to record data in the recording medium, and an interface for conducting data input and output operations. Information to control recorded and unrecorded areas in areas in the recording medium is recorded in the recording medium. When the information to control recorded and unrecorded areas is updated, the information is recorded in the recording medium at predetermined timing. One of flags indicating respective types of the timing of the update is recorded in the recording medium.

According to one aspect of the present invention, there is provided a recording medium in which information to control recorded or unrecorded areas in recording areas is recorded. When the information to control recorded and unrecorded areas is updated, the information is recorded in the recording medium at predetermined timing. One of flags indicating respective types of the timing of the update is recorded in the recording medium.

According to the present invention, in the data recording operation in a write-once disk, the recorded and unrecorded areas can be known without conducting a detecting or sensing operation on the overall surface of the disk. This reduces the period of time required for the control operation. By disposing a recorded/unrecorded area control map in a nonvolatile memory and by additionally using a flag indicating an event that updated information has been recorded in the disk, whether or not the recorded/unrecorded area control map recorded in the disk is correct can be determined even at occurrence of power failure. It is not necessarily required to use such a flag. That is, by overwriting recorded data to cause or produce an error at a particulate position, information similar to that of the flag can also be provided.

By arranging a flag indicating an update timing rule for each of devices having mutually different points of update timing and by recording data in a disk together with control information, an update rule used to record control data can be determined for each disk.

Other objects, features and advantages of the invention will become apparent from the following description of the embodiments of the invention taken in conjunction with the accompanying drawings.

### BRIEF DESCRIPTION OF THE DRAWINGS

FIG. 1 is a block diagram showing an example of a configuration of an embodiment of a system which records data in a disk and which reproduces data from the disk according to the present invention.

FIG. 2 is a diagram showing recorded and unrecorded areas and the contents of a control map of the areas in an embodiment of the present invention.

FIG. 3 is a diagram showing an example in which data recording areas and a recorded and unrecorded area control map are recorded in a write-once optical disk.

FIG. 4 is a diagram showing an example in which identifying information is added by overwriting data over recorded data in a disk.

FIG. 5 is a diagram showing a block data layout of record data described in non-patent article 1.

FIG. 6 is a diagram showing a layout of an LDC code shown in FIG. 5.

FIG. 7 is a diagram showing an example in which a particular burst error is caused by overwriting data in the record block layout shown in FIG. 5.

FIGS. 8A and 8B are diagrams showing burst errors shown in FIG. 7 using the LDC layout of FIG. 6.

FIG. 9 is a flowchart showing a processing flow to update the contents of the recorded and unrecorded area control map.

FIG. 10 is a diagram showing a layout of the recorded and unrecorded area control map and an update flag.

FIG. 11 is a diagram showing an example of control using recorded and unrecorded area control maps arranged in a disk.

FIGS. 12A and 12B are tables showing examples of the recorded and unrecorded area control maps recorded by devices having mutually different points of timing to record the maps.

FIG. 13 is a diagram showing an example in which the update flag is recorded in a disk together with the recorded and unrecorded area control map.

FIGS. 14A and 14B are diagrams showing additional recording of areas (4), (6), and (7) in a recorded area.

FIGS. 15A to 15E are diagrams showing an example of a processing flow to encode record data.

FIG. 16 is a diagram showing an example of identifier data including a signal to identify a recording direction.

FIG. 17 is a diagram showing an example of synchronizing data including a signal to identify a recording direction.

FIG. 18 is a flowchart showing an example of a processing flow to set a recording direction flag in a data recording operation.

FIG. 19 is a diagram showing an example of a recording medium including a disk identifier code.

FIG. 20 is a diagram showing an example of a state in which a disk identifier code is stored in a nonvolatile memory.

### DESCRIPTION OF THE EMBODIMENTS

Referring now to the drawings, description will be given of an embodiment of a recording method according to the present invention.

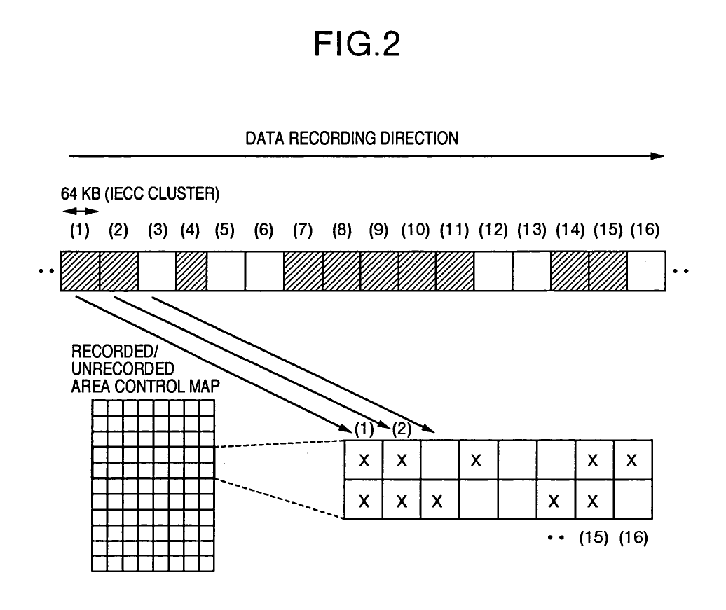

FIG. 2 shows recorded and unrecorded areas and control information of the areas in an embodiment of the present invention. An upper section of FIG. 2 shows recording areas in a disk. Hatched areas (1) to (4), (7) to (11), and (14) and (15) are recorded areas in which data has already been written. The other areas (3), (5), (6), (12), (13), and (16) not hatched are unrecorded areas in which data has not been written yet.

Assume that the address value becomes greater in the disk in a direction from the left side to the right side and data is recorded in a recording direction indicated by an arrow. Data is written in the unit of 64 kilobytes (kB) in this example. In the recorded/unrecorded area control map, one bit is assigned to each recordable area in the disk. For example, “1” and “0” are respectively assigned to a recorded area and an unrecorded area. In an identifying map, which will be called a space bit map hereinbelow, bits are assigned according to each recording unit to identify recorded and unrecorded areas of recordable areas so that the recorded and unrecorded states are determined later. When data is recorded in a recording unit of 64 kilobytes in a recording area of 25 gigabytes (GB), the identifying map requires about 400000 bits, i.e., about 50 kilobytes (kB).

A lower section of FIG. 2 shows an example of the recorded/unrecorded area control map. This is a file having a size capable of controlling recordable areas of a disk. Part of the file is assigned to the recorded and unrecorded areas shown in the upper section with a correspondence establish therebetween.

When new data is recorded in a disk, a recorded/unrecorded area control map is saved in the disk at predetermined timing. As a result, the recorded and unrecorded areas can be known by reading the map without actually scanning the surface of the disk for the recorded and unrecorded areas. Therefore, for example, to record data in an unrecorded area in the finalizing session, such an unrecorded area can be readily determined. Also in an ordinary recording operation, data items can be written in the unrecorded areas beginning, for example, at an address having a smallest address value. Since it is possible to determine the size of an area in which data can be continuously written, a recording area suitable for data to be continuously reproduced such as video data can be easily detected.

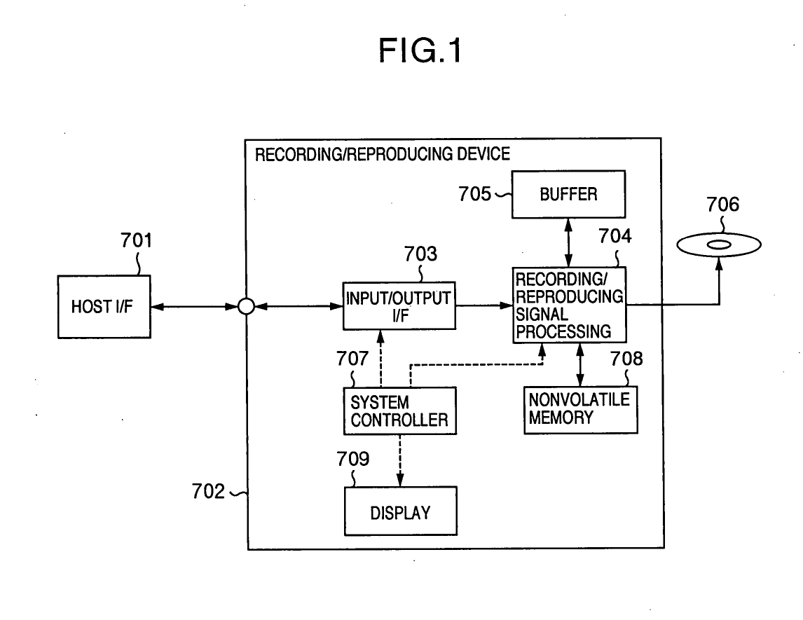

FIG. 1 shows an example of a configuration of a system which conducts data recording and reproducing operations in a disk. Numeral 701 indicates an interface on the host side, numeral 702 is a device to conduct data recording and reproducing operations, numeral 703 is an input/output interface, numeral 704 indicates a signal processing circuit, numeral 705 indicates a buffer for the signal processing, numeral 706 is an optical disk, numeral 707 indicates a system control circuit, numeral 708 is a nonvolatile memory, and numeral 709 is a display.

The host interface 701 is a device such as a personal computer and issues a data input/output request. The request is issued, for example, with a disk address specified therein to record data at a predetermined area or to read data from an area at the address. The input/output interface 703 receives data to be recorded in a disk, outputs playback data reproduced by the system, and communicates commands to control data. When recording data in a disk, the signal processing circuit 704 conducts a data encoding operation in which an error correction code is added to the data according to a recording format and the data is modulated. When reproducing data, the circuit 704 conducts a data decoding operation in which the data is demodulated and any error of the data is corrected. In the signal processing, data is temporarily stored in the buffer 705 depending on cases. An optical pickup, not shown, records data in the disk 706 and hence recorded and unrecorded areas exist in the disk 706. If a rule that data is written in the disk beginning at, for example, an inner circle is used, the recorded and unrecorded areas are separated from each other. Using information indicating a last address of the recorded area, it can be determined that any areas with addresses equal to or less than the address are recorded areas and any areas with address more than the address are unrecorded areas. However, the use of such a rule restricts usability of the system depending on cases. For example, in a rewritable optical disk, data can be overwritten as many times as desired. Therefore, when unnecessary data is deleted from the disk with necessary data kept remained thereon and other data is overwritten in the disk, the available recordable areas are dispersed in the disk in a random fashion. If a write-once disk can be controlled in almost the same way as that of the system described above, the system control can be arranged in a common manner and hence can be simplified. Consequently, there possibly exists a in which not only for the rewritable optical disk but also for the write-once optical disk, the data recording and reproducing operation are conducted while allowing the random recording operation. In this case, control of recorded and unrecorded areas become important and it is required to appropriately devise or modify the control method. If a search is made over the overall surface of the disk for the recorded and unrecorded areas, quite a long period of time is required. To reduce the time, a map to control the recorded and unrecorded areas described above is used to determine the areas without scanning the overall disk surface for each area determination.

When recording data in a recording medium, the host interface 701 records the data by specifying a logical address assigned to a user data area. Ordinarily, also the host personal computer recognizes recorded and unrecorded areas using a logical address. However, this differs from the technique associated with the recorded and unrecorded area control map of the present invention because the map corresponds to recorded and unrecorded areas of the recording medium. The recorded and unrecorded areas can be recognized on the drive side. In addition to information of the recorded and unrecorded area recognized by the personal computer on the host side, there is stored information obtained as below. In an operation to write data in the disk, when a defect occurs in the recording medium, another area is assigned and the data is written in the area. Information indicating a correspondence between the defective area and the area assigned in place thereof is also stored. Therefore, it is possible to obtain information of recorded and unrecorded areas corresponding to physical addresses of the recording medium.

The system control circuit 707 controls the overall operation of the system. The controller 707 reads the recorded and unrecorded area control map from the disk 706 and stores the map in the nonvolatile memory 708. The map is updated in the memory 708 and is recorded in the disk 706 at predetermined timing. The contents of the nonvolatile memory are not lost even if power is turned off. Even when the power fails before the latest recorded and unrecorded area control map is recorded in the recording medium, i.e., the disk, the contents of the map are kept retained. Naturally, the map may be stored in the buffer memory 705. Although the recorded and unrecorded area control map may be written in the disk each time the map is updated, a large control area is required when the disk is a rewritable disk. To overcome the difficulty, the map is written in the disk only when the disk is removed or when power is turned off. When the map is updated, the map is written again in the nonvolatile memory 708 to thereby reduce the number of writing operations in the disk. Ordinarily, the recorded and unrecorded area control map is stored in the buffer memory 705, and the nonvolatile memory 708 is used only when the map is updated. This reduces the number of rewriting operations in the nonvolatile memory 708.

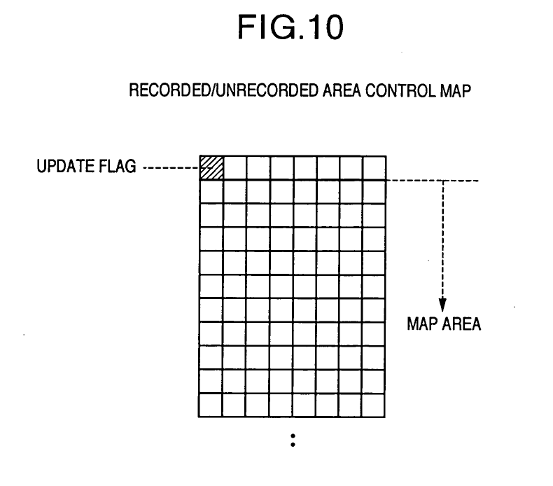

When an update flag indicating whether or not the latest recorded and unrecorded area control map has been recorded in the disk is disposed and is stored in the nonvolatile memory as shown in FIG. 10, it is possible to determine whether or not the recorded and unrecorded area control map in the disk is a latest one. Specifically, if the update flag is set when the contents of the map is even partially updated and the flag is reset when the recording in the disk is finished, whether or not the latest map is already recorded in the disk can be easily determined.

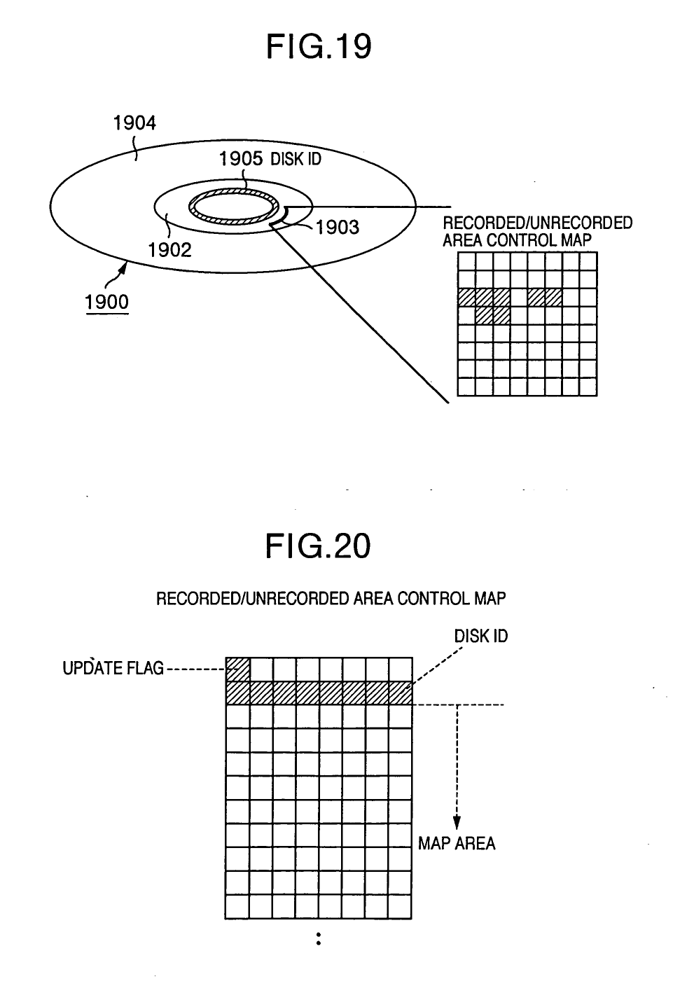

FIG. 19 shows an example in which a disk identifier or a disk identifier code and a recorded/unrecorded area control map are recorded in a disk. A recording-type optical disk 1900 includes a control area 302 to record control information and a data recording area 1904 to record user data. In an operation to record data in the data recording area 1904, a recorded and unrecorded area control map is recorded in a predetermined location of the control area 1902 at predetermined timing. The disk identifier code 1905 is beforehand recorded in a predetermined area of the disk to identify each disk. It is assumed in the embodiment that the disk identifier code is recorded when the disk is produced. However, the identifier code may be assigned by the recording and reproducing apparatus to be recorded in a particular area of a disk. FIG. 20 shows an example in which the disk identifier code shown in FIG. 19 is recorded in a nonvolatile memory. By storing the identifier code in the nonvolatile memory, when power fails with the update flag kept set and another disk is then installed in the disk drive in this state, it is possible to identify the disk by the disk identifier code. Therefore, it is possible to recognize that the recorded and unrecorded area control map is also changed. In this case, by displaying the state that the disk has been replaced on the display 709 or by displaying the disk identifier code of the disk used up to the point of power failure on the display 709, the user can replace the disk with a correct disk. The disk identifier code may be a disk identifier beforehand recorded in the disk when the disk is produced. Or, a number to identify a disk arbitrarily assigned by the recording and reproducing apparatus 702 or a name assigned by the user may also be used as the disk identifier code.

Although the display 709 is disposed in the recording and reproducing apparatus 702 in the embodiment, the present invention is not restricted by the configuration. In a case in which a display is arranged, for example, on the host personal computer side, by sending a signal indicating that the disk is different from the disk used before to the host interface 701, the host side can conduct an appropriate operation, for example, to display the condition on the display.

The timing to record the recorded and unrecorded area control map in a recording medium is as follows. For example, when the recording is conducted when the disk is removed or when power is turned off, the latest information of the map is recorded. When any item of the contents of the map is updated, that is, when the update flag is set, the contents of the map are recorded in the disk. However, when the recording is conducted too frequently, the area to record control information becomes insufficient. Therefore, when the contents of the map has not been changed, the recording of the contents is not conducted. It is also possible to increase reliability by repeatedly recording the recorded and unrecorded area control map in mutually different areas. As a finalizing operation to prevent any writing operation in the disk thereafter, it may also possible to write the map in a predetermined area in the disk.

Thanks to the control operation, when a disk is installed in the disk drive, the recorded and unrecorded areas can be recognized by reading the recorded and unrecorded area control map without scanning the overall surface of the disk.

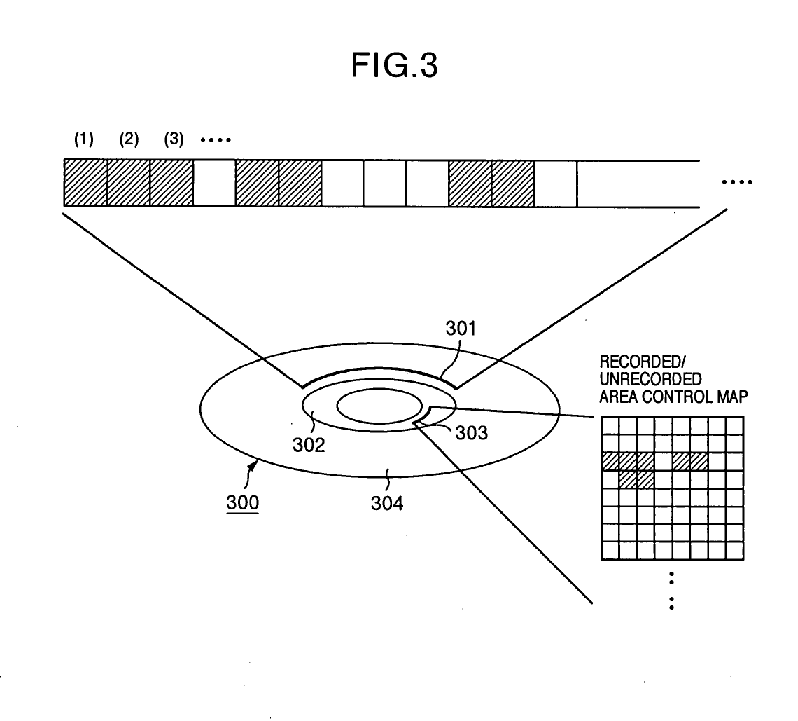

FIG. 3 shows an example in which data recording areas and a recorded and unrecorded area control map are recorded in a recording-type optical disk. The rewritable optical disk 300 includes a control area 302 to record control information and a data recording area 304 to record user data. In an operation to record data in the data recording area 304, data is written in the disk as indicated by a reference numeral 301. A recorded and unrecorded area control map is recorded in a predetermined area of the control area 302 at predetermined timing. To guarantee reliability, it is also possible to repeatedly record the recorded and unrecorded area control map in mutually different areas in the control area 302. Or, another control area may be disposed in another place. When the control area becomes full of data, part of the data recording area 304 may be used for the control area.

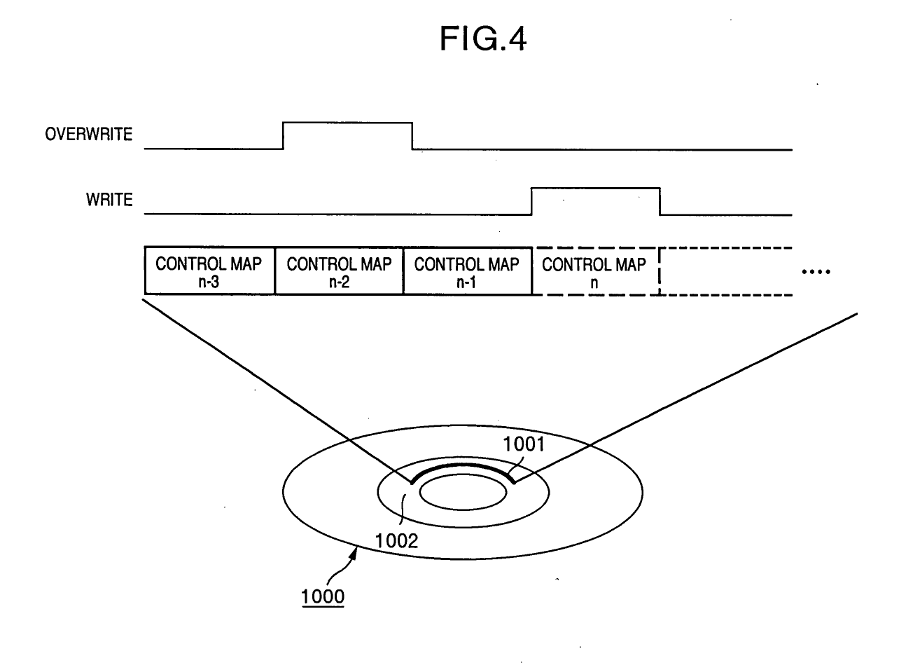

FIG. 4 shows an example in which whether or not an update operation is already been conducted can be determined without using the update flag described above. That is, data is overwritten over recorded data to cause an error in the recorded data. A recorded and unrecorded area control map 1001 is recorded in a control area 1002 in the disk 1000. The map 1001 is updated at predetermined timing. The recorded maps are indicated as n−3, n−2, and n−1 beginning at an oldest one thereof. On a write-once optical disk, when a laser beam is emitted onto recorded data, namely, when an overwriting operation is conducted, the characteristic of the recording layer of the disk is changed and data is destroyed. As a result, the original data recorded thereon cannot be read therefrom. Also in a rewritable optical disk, when data not associated with the data beforehand written in the area is recorded thereon, an error occurs in the data. Without disposing the update flag, this phenomenon can be used as follows. When a disk is installed in the drive, an overwriting operation is conducted in the recorded/unrecorded area control map 1001 (n-2) to destroy the data. This indicates the update of the map 1001. When the map 1001 is next updated, a recorded/unrecorded area control map 1001 (n) is recorded.

A new recorded/unrecorded area control map 1001 (n-1) is possibly used thereafter and hence is kept remained for use in the future. The overwriting is conducted at timing other than the timing of installation of a disk. First, at timing of update of the recorded and unrecorded area control map 1001, the overwriting is first conducted on the map 1001 (n-2). If the map 1001 (n) has been fully recorded, it is assumed that the map 1001 has been completely recorded. As a result, the event that the map 1001 has normally been written can be detected without using the update flag. If data has not been written in the disk after its installation and the disk has not been removed, information in the nonvolatile memory can be used as the recorded and unrecorded area control map 1001. Also when one recorded/unrecorded area control map 1001 exists in the disk, even if the contents thereof are different from those of the information in the nonvolatile memory, the information in the nonvolatile memory can be used as the recorded and unrecorded area control map 1001.

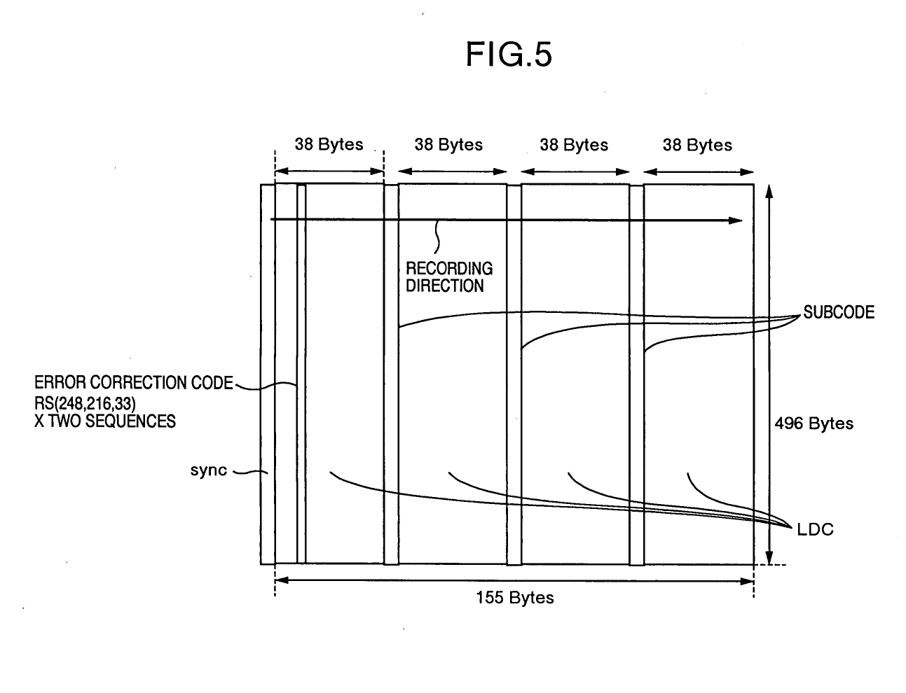

FIG. 5 shows and example of a block layout of record data described in “Optical Disc System for Digital Video Recording (Jpn. J. Appl. Phys. Vol. 39 (2000) Pt. 1, No. 2B FIG. 2). User data is encoded in a data unit of 64 kilobytes to configure a unit of 496 bytes ×155 bytes including a long distance code, address information called a burst indicator subcode, and a subcode. The record data is sequentially recorded in a recording medium in a direction indicated by a bold arrow. For example, the recorded and unrecorded area control map is recorded in this data layout in a disk.

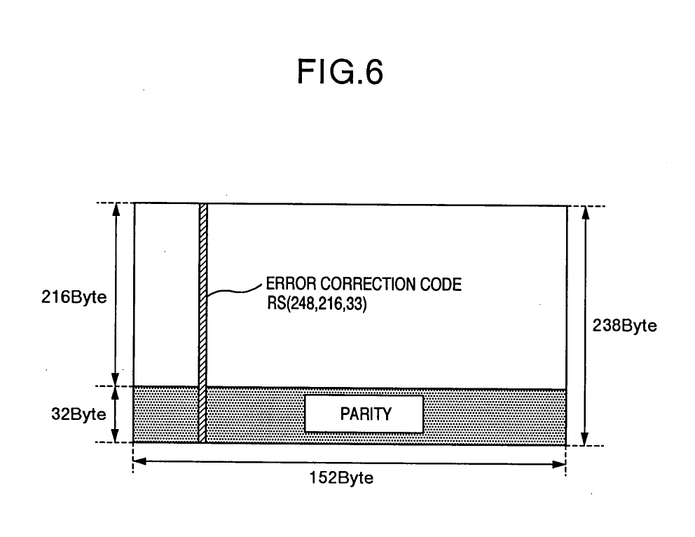

As can be seen from FIG. 6, the LDC encoding is conducted using Reed-Solomon (RS) code such that 32 parity bytes are added to data of 216 bytes to form a data layout of 248 bytes ×152 bytes. One unit of LDC data includes two blocks of “248 bytes ×152 bytes”.

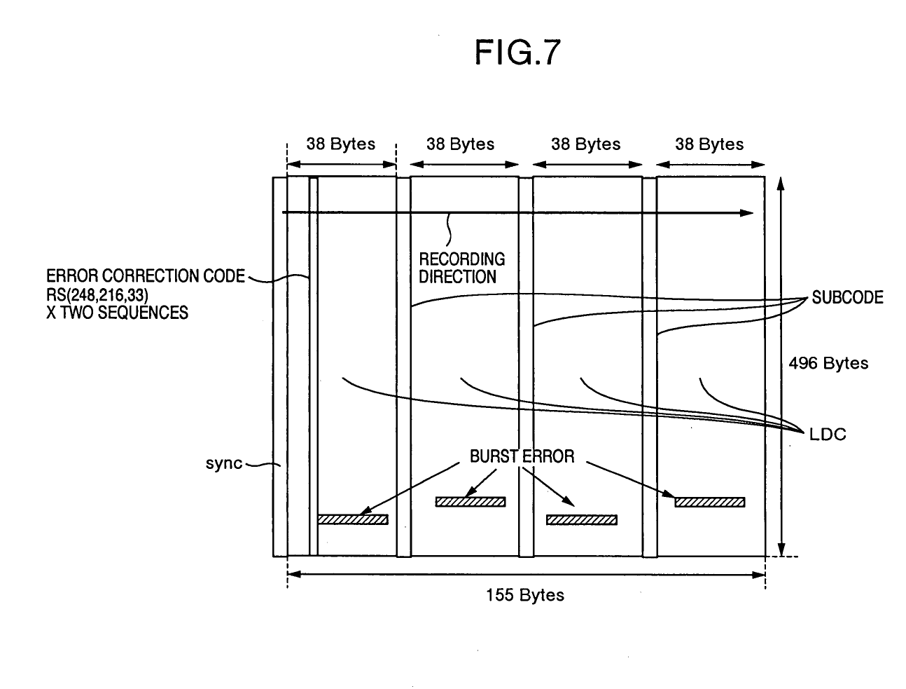

FIG. 7 shows a case in which an overwriting operation is conducted for the record block configuration of FIG. 5 to cause particular burst errors. Small hatched rectangles indicate burst errors. By determining the error positions in advance, an error intentionally created by the overwriting can be discriminated from any other errors in the disk. Although four burst errors are shown in the embodiment, the burst length and the number of burst errors are not restricted by the embodiment. In this regard, if the burst error is longer than a continuous pattern with a largest length generated on the modulation side in the system, the burst error can be more easily recognized as an error pattern.

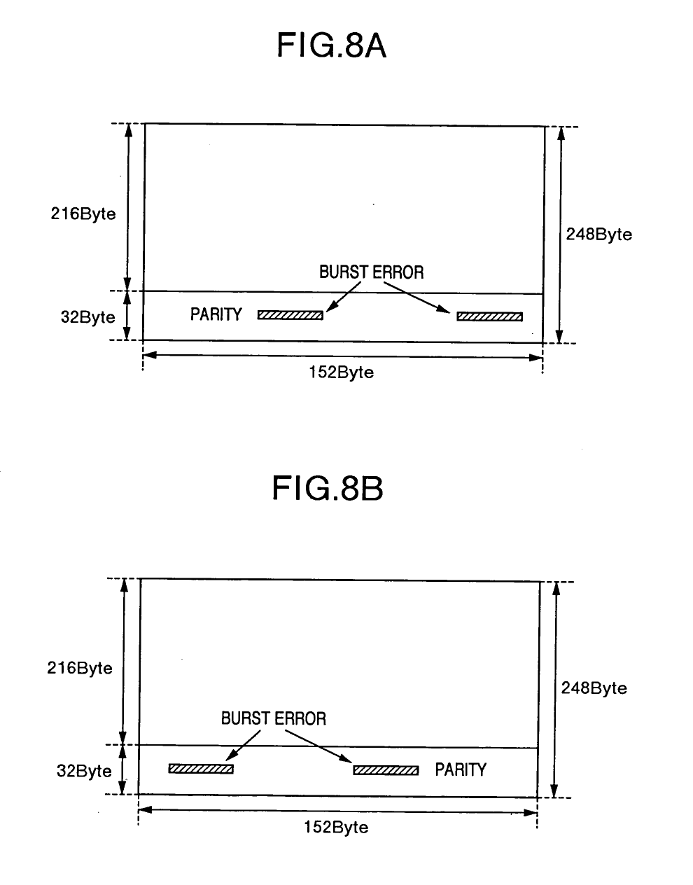

FIGS. 8A and 8B show the burst errors of FIG. 7 in the LDC layout shown in FIG. 6. In this situation, by causing a particular error in LDC blocks through the overwriting in, for example, FIGS. 8A and 8B, an event in which burst errors are concentrated to either one LDC can be prevented. By arranging errors in a dispersed way as above, the error positions can be appropriately detected. That is, it is possible to detect particular error positions each of which indicates a function similar to that of the update flag. The errors are created only in the parity zone. Therefore, such errors can be created without destroying the data zone actually used for processing.

Up to 16 error positions can be independently detected when the Reed-Solomon code is used. Therefore, when any other error does not occur, up to 16 errors may be created in one (vertical) column. This means that a particular error position may be detected by combining several error positions with each other. In conjunction with the embodiment, description has been given of an example of occurrence of a burst error which is a continuous error. However, it is also possible to use an error which occurs alone, and such an error may be created at several positions.

Even without updating the update flag, information of recorded/unrecorded areas can be approximately obtained. Therefore, it is only required to make a check for recorded or unrecorded areas in the vicinity of a position indicated by the information. The time required to determine the recorded or unrecorded areas can be reduced as compared with the detection conducted by scanning the overall surface of the disk.

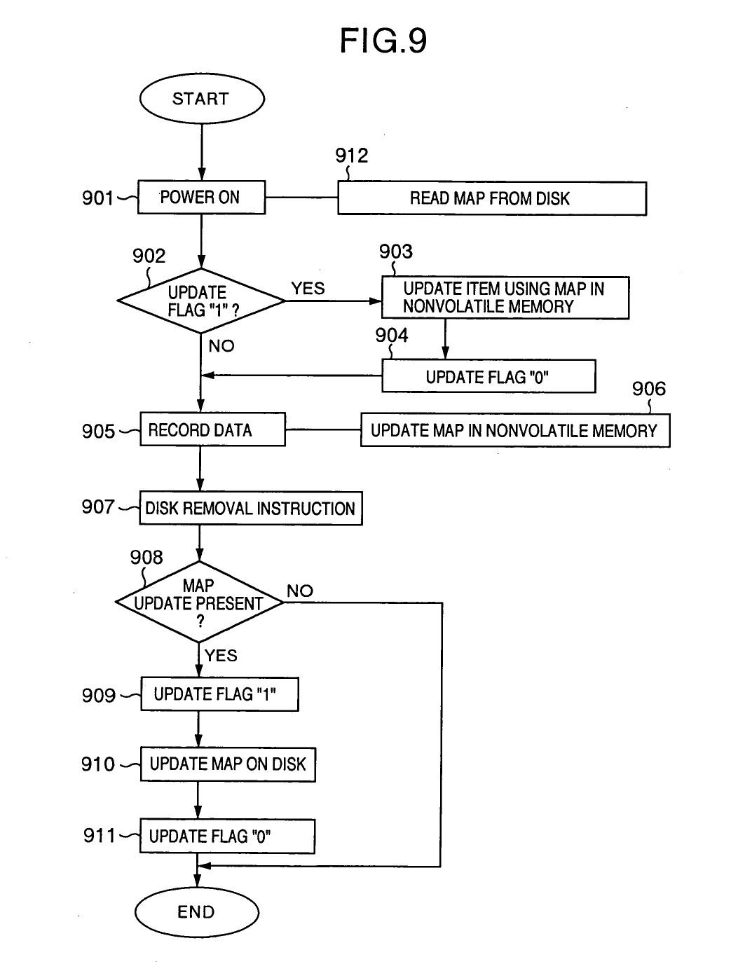

FIG. 9 shows a processing flow to update a recorded/unrecorded area control map using the update flag described by referring to FIG. 1. When the map is updated at removal of a disk, the flow of processing begins at step 907 for a disk removal instruction. Description will be hence given beginning at step 907. Having received a disk removal instruction from the host side (step 907), a check is made to determine whether or not a data recording operation is conducted and an update operation of the recorded/unrecorded area control map is required (step 908). If the update is not required, the disk is ejected and the processing is terminated. If the update is required, the update flag is set to “1” (step 909). If the update flag is kept retained even when power is turned off, the update flag can be recorded at any place. However, this operation consumes some area in the write-once disk, and hence the update flag is stored in the nonvolatile memory in this case. The latest recorded/unrecorded area control map is recorded in the disk (step 910). The update flag is reset to “0” (step 911) and the disk is removed to terminate the processing.

Description will now be given of operation of the system when power is turned on. Ordinarily, in a case in which the disk is kept unchanged, after power is turned on (step 912), the recorded and unrecorded area control map is read from the disk (step 901). A check is made for the update flag (step 902). If the flag is “0”, it is indicated that the previous disk removal has been normally finished, and hence the system does not execute any particular processing. However, if the update flag has not been reset and is “1”, it is assumed that failure has occurred during the operation to record the map in the disk. The map in the disk is then compared with that stored in the nonvolatile memory. If these maps are different from each other, the map read from the disk is updated using the map in the nonvolatile memory (step 903). Thereafter, the update flag is reset to “0” (step 904) to restore the ordinary state (steps 905 and 906). Operation after this point is the same as for the ordinary situation. By the processing described above, it can be confirmed that the recorded/unrecorded area control map has been normally updated and has been normally recorded in the disk.

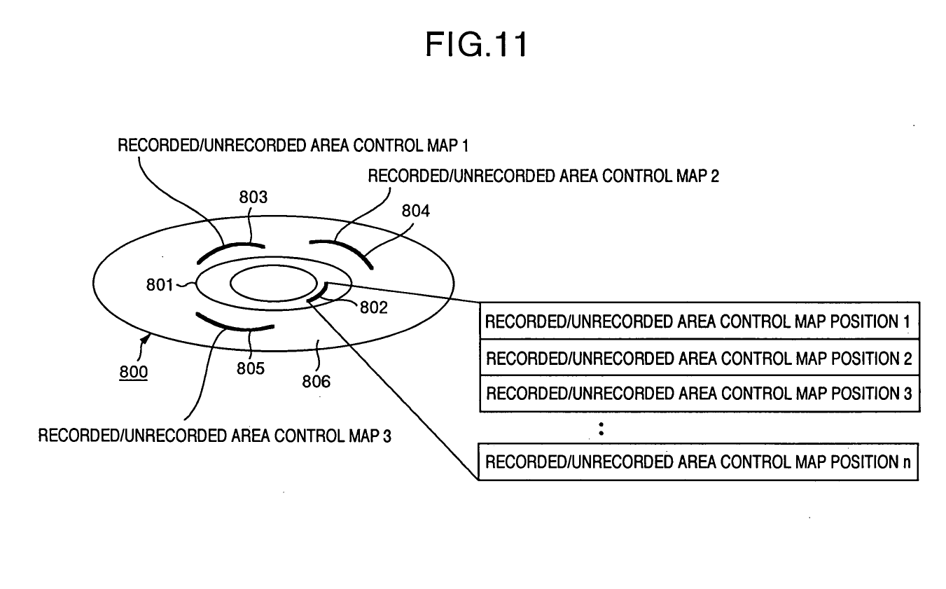

FIG. 11 shows an example in which the recorded/unrecorded area control map is not arranged at a particular position but is disposed, for example, in an available area of the record area 806 for the user data. Numeral 800 indicates an optical disk, numeral 801 indicates a control area, numeral 802 is a recorded and unrecorded area control map position file, numeral 803 indicates a recorded/unrecorded area control map 1, numeral 804 indicates a recorded/unrecorded area control map 2, and numeral 805 indicates a recorded/unrecorded area control map 3. When the control map is randomly disposed as shown in FIG. 11, information to indicate positions of the maps is arranged in the control area 801 to indicate a recording position of the latest file. In this case, it is not required to arrange any particular area for the recorded/unrecorded area control maps. Such an area of the map can be reserved in the user data area according to necessity. Particularly, for example, when a small file having a relatively small capacity is used on a personal computer, namely, when the file is rewritten frequently, any particular control area is not reserved. Therefore, the operation described above is efficient. It is assumed that the map position file 802 includes the latest position information at a last position or the first position thereof. Therefore, the latest information can be readily known in the file 802. Naturally, by repeatedly writing the recorded/unrecorded area control map and the map position file 802 a plurality of times, reliability thereof can be guaranteed.

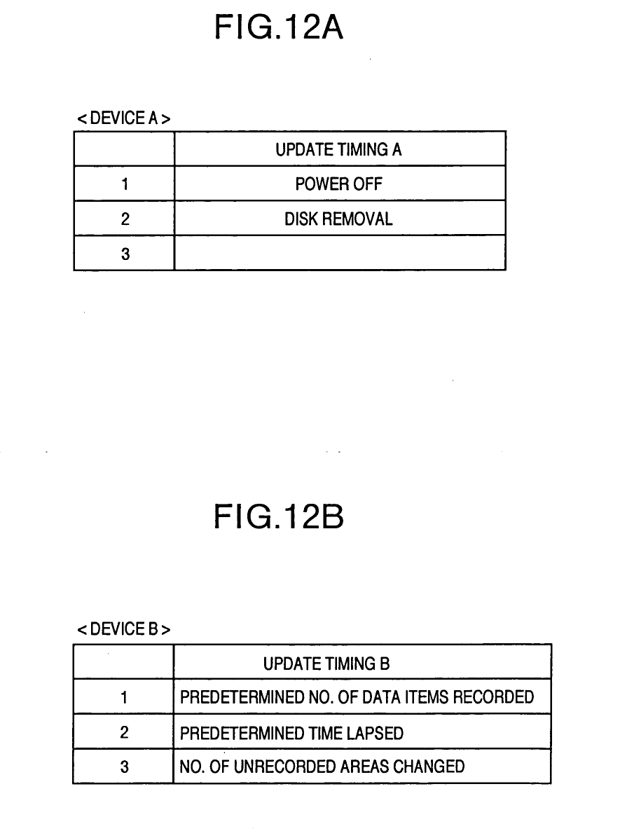

FIGS. 12A and 12B show examples in which the recorded and unrecorded area control map is recorded by devices having mutually different points of timing to record the map. Device A updates the map at update timing A. Device B updates the map at update timing B. In a case in which device A is, for example, an audiovisual device to record video images and music pieces, the recorded/unrecorded area control map is updated at timing when power is turned off or when a disk is removed. In a case in which device B is a device such as a personal computer to record data, the map is updated at timing when a predetermined number of data blocks are recorded after the map is previously recorded or at timing when the number of unrecorded areas changes. This is because it rarely occurs that an audiovisual device turns off suddenly. It is possible that after power is turned off, the map is updated and then power of the disk drive is turned off. However, there possible occurs in a disk drive for a personal computer that power is suddenly turned off due to abnormal operation in some cases. That is, the actual recorded and unrecorded areas do not match the recorded and unrecorded area map to some extent. Therefore, the map is updated when a predetermined number of blocks are recorded or when a predetermined period of time lapses. Due to the discrepancy, it is required at restart of the disk drive that an area last recorded is retrieved to confirm the recorded and unrecorded areas. When the recorded and unrecorded area map is updated by devices having mutually different points of timing to update the map, information indicating the update timing rule which causes the map update is important. Therefore, a flag corresponding to the update timing rule is recorded in the disk together with the recorded/unrecorded area map.

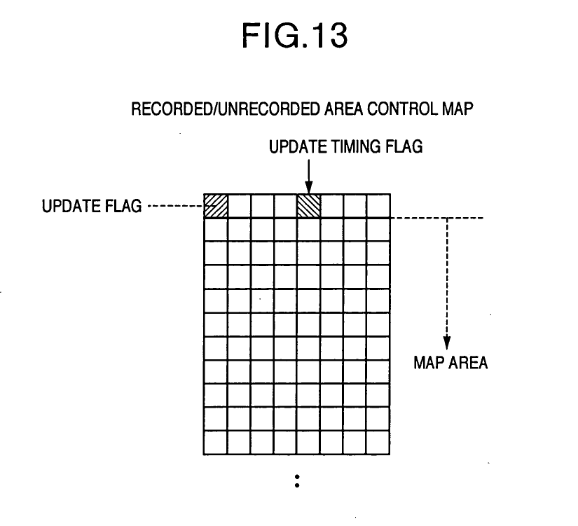

FIG. 13 shows an example in which the update flag is recorded together with the recorded/unrecorded area control map. FIG. 12 shows an example of two types of update timing. It is only necessary to assign a bit for a flag according to each type. By recording these flags in the disk, when the disk recorded in advance is read by another device, the update timing can be determined for the recorded/unrecorded area control map associated therewith by using the flags and hence processing can be appropriately executed. When a flag corresponding to, for example, update timing A is recorded, the recorded/unrecorded areas correspond to the recorded/unrecorded area map. Therefore, the system can be started a high speed when power is turned on or when a disk is installed. When the map is recorded at update timing B, an area last recorded is retrieved to confirm the recorded/unrecorded areas and then the system is started. The flag arrangement shown in FIG. 13 is naturally an example, and the present invention is not restricted by the example.

In FIG. 12, each update timing is indicated as a rule including two or more points of update timing. However, it is also possible that a flag is assigned to each point of update timing so that the update timing is determined for each update of the recorded/unrecorded area map. It is also possible to assign mutually different flags to respective points of update timing as follows. For example, an update flag “1” is assigned to the update timing “power off”, an update flag “2” is assigned to the update timing “disk removal”, and an update flag “3” is assigned to the update timing “predetermined number of blocks” and the flags are recorded in the disk.

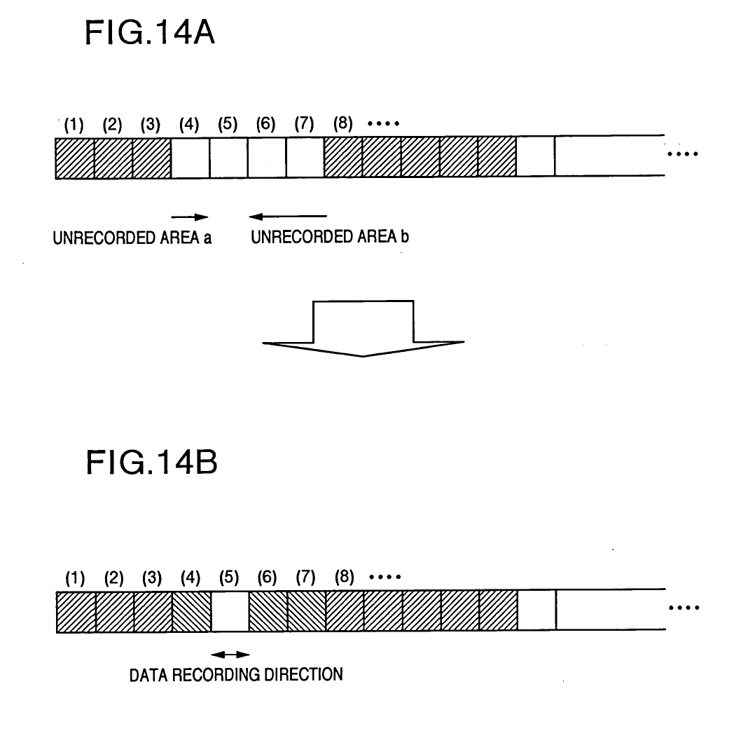

FIGS. 14A and 14B show additional recording areas (4), (6), and (7) recorded in addition to recorded areas (1), (2), (3), (8), (9), and so on. In addition to the recorded areas (1), (2), and (3), data is recorded in the area (4) in a recording direction (a). In addition to the recorded area (9) . . . , data is recorded in the areas (7) and (6) in a recording direction (b). FIG. 14B shows the recorded areas after the recording operation described above. As a result, FIG. 14B shows an unrecorded area existing as a gap between the recorded areas. In this case, the unrecorded area is quite small, and hence it is difficult to detect the unrecorded area through the scanning operation. Therefore, it is required to easily detect such a small area. Description will now be given of a method to dispose an identifier signal in the data recorded in such a small area. However, it is assumed that a predetermined number of blocks are continuously recorded in one direction without changing the recording direction.

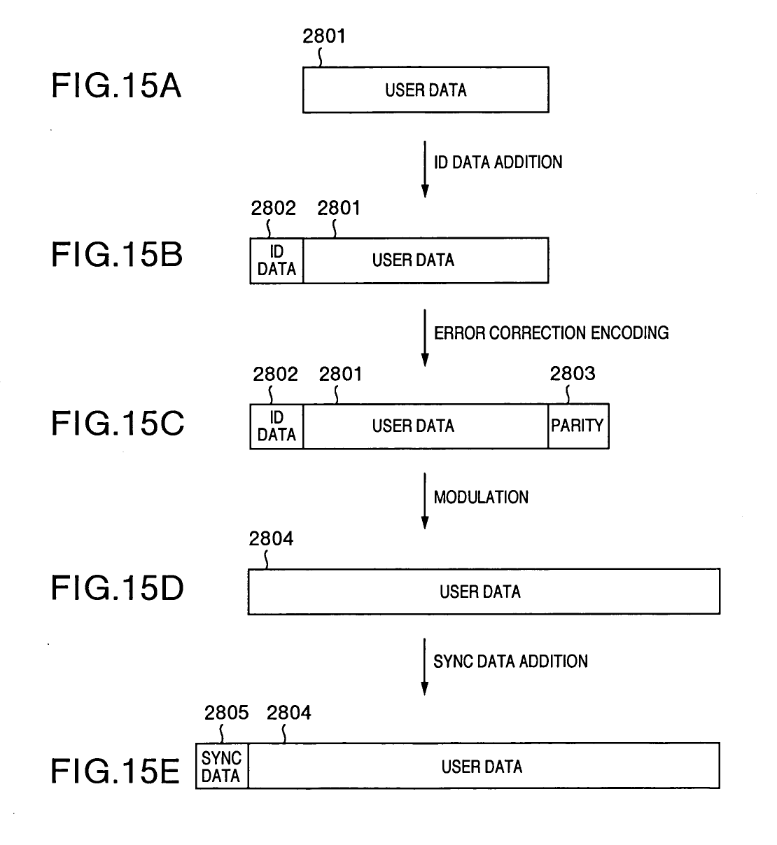

FIGS. 15A to 15E show an example of a flow of processing to encode record data. The processing flow is also applicable to the record block layout shown in FIG. 11. As can be seen from FIG. 15B, identifier data 2802 is added to user data 2801 (FIG. 15A). Information of parity data 2803 is added thereto through an error correction encoding operation (FIG. 15C). The resultant data is modulated to obtain modulated data 2804 (FIG. 15D). Synchronizing data 2805 is added to the modulated data 2804 to produce record data in a format to be recorded in a recording medium (FIG. 15E).

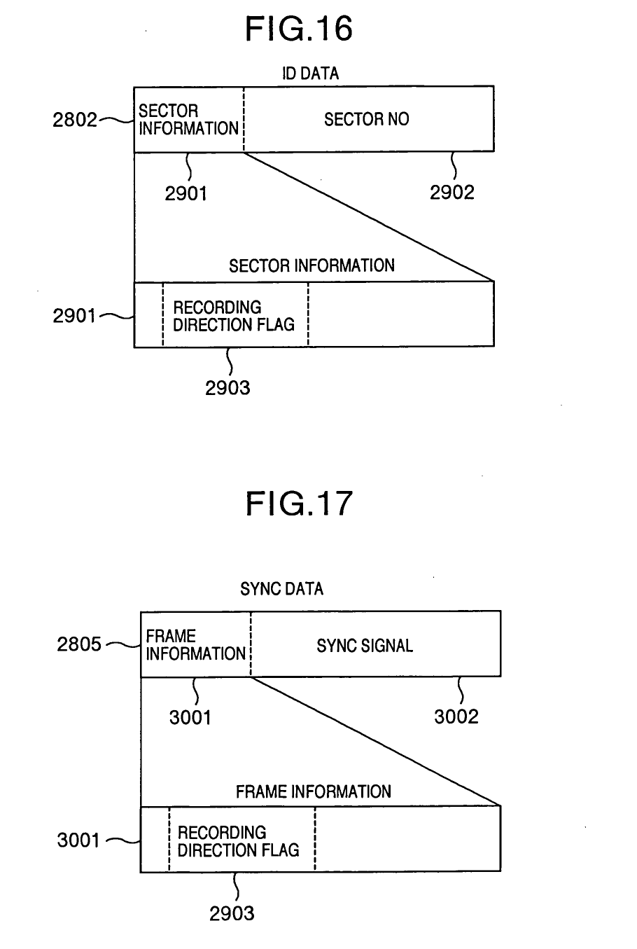

FIG. 16 shows an example of the identifier data 2802 including an identifying signal. The identifier data 2802 includes sector information 2901 and a sector number 2902. The sector information 2901 includes additional information regarding an associated sector. The sector number 2902 includes information of an address indicating a physical position in the recording medium. A recording direction flag 2903 indicating a recording direction is added as a subitem of the sector information 2901. The recording direction flag 2903 is used to indicate, when the record data is to be recorded adjacent to an already recorded area, whether the record data is recorded to be adjacent to a recorded area existing in a forward direction a or in a backward direction b. Thanks to provision of the flag 2903, even when the recorded and unrecorded area map is not updated for each data recording operation, the recorded area and the recording direction of the record data recorded after the update of the map can be known. Even when a small unrecorded area remains between two areas, the small area can be detected by using the recording direction flag. The identifier data 2802 shown in FIG. 16 corresponds to the subcode described in conjunction with FIG. 11.

FIG. 17 shows an example of synchronizing data including the recording direction flag of FIG. 16. The synchronizing data 2805 includes frame information 3001 and a synchronizing signal 3002. The frame information 3001 includes additional information contained in an associated frame. The synchronizing signal 3002 is a timing signal used to obtain, according to the timing of this signal, the unit of data to encode data. Since the frame information 3001 includes the recording direction flag 2903, even when a small unrecorded area remains between two areas, the small area can be detected.

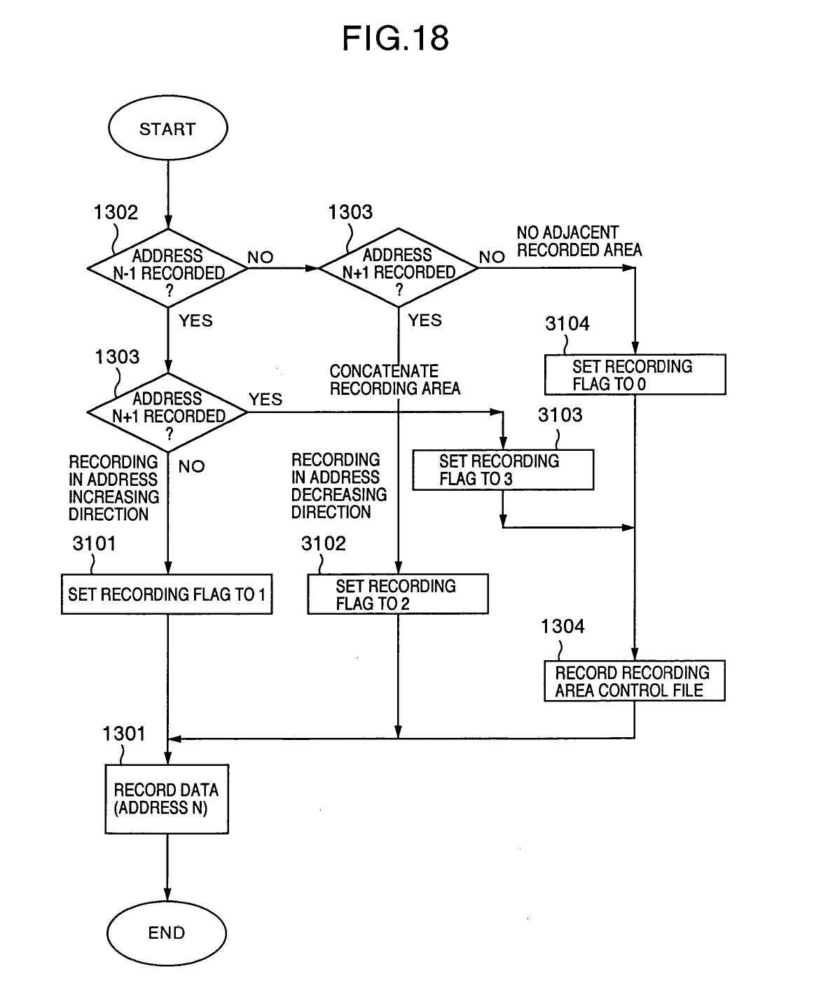

FIG. 18 shows an example of processing to set the recording direction flag when data is recorded. Using address N at which data is to be recorded, a check is made to determine whether or not an area at address N−1 is a recorded area (step 1302). Next, a check is made to determine whether or not an area at address N+1 is a recorded area (step 1303). As a result, it is possible to discriminate a case to record data in an address decreasing direction, namely, in a descending address sequence from a case to record data in an address increasing direction, i.e., in an ascending address order. When the data is recorded in an address decreasing direction, the recording direction flag is set to “1” (step 3101). When the data is recorded in an address increasing direction, the recording direction flag is set to “2” (step 3102). When the record area is not adjacent to an recorded area, the areas at addresses N−1 and N+1 are unrecorded areas, and hence the recording direction flag is set to “0” (step 3104). When the areas at addresses N−1 and N+1 are recorded areas, two record areas are concatenated, and hence the recording direction flag is set to “3” (step 3103). In this situation, the recording direction flag may be “1” or “2”. When the recording direction flag is “0” or “3”, the data is recorded in a new area or the areas are concatenated. Therefore, the recorded and unrecorded area map is updated (step 1304). After the flag is set as above, data is recorded in the recording medium (step 1301). Since data is ordinarily recorded in the address increasing direction, one recording direction flag can be used to indicate the states “1”, “0”, and “3”. It is also possible that without setting the recording direction flag to “1”, “0”, and “3”, only the record direction flag “2” indicating the address decreasing direction is set in the processing. Setting up the recording direction flag, even when the recorded/unrecorded area are scanned in the recording medium, the recording direction can be known at an address detected by the scanning operation and hence an unrecorded area can be detected.

For a recording medium such as a write-once optical disk, control of recorded and unrecorded areas is important. For a rewritable recording medium, control of recorded and unrecorded areas is also important when the recording characteristic is changed depending in recorded and unrecorded areas. In the description, a data recording address is specified by the disk drive. However, similar control is possible even when the address is indicated from the host interface.

According to the embodiment of the present invention described above, when recording data in a recording medium, recorded and unrecorded areas can be known without scanning the overall surface of the disk. This advantageously reduces the period of time required to control the recorded and unrecorded areas. By storing a recorded and unrecorded area control map in a nonvolatile memory and by arranging a flag indicating that updated information is already recorded in the disk, whether or not the recorded and unrecorded area control map recorded in the disk is correct can be determined even at failure such as power off due to an abnormality. A similar advantage can be obtained without using the flag described above. That is, by causing an error at a particular position through an overwriting operation of data in recorded data, information similar to that of the flag can be obtained.

In the recording method of the embodiment of the system configuration shown in FIG. 1, a recorded/unrecorded area map position file is stored in a nonvolatile memory, and the file is recorded in a recording medium at predetermined timing.

In the description of the embodiment, a recordable optical disk is used as an example of the recording medium. However, the embodiment does not restrict the present invention. That is, the present invention is applicable to any recording operation in a recordable recording medium. Although a data recording address is specified by the disk drive in the description, similar control is possible even when the address is indicated from the host interface.

It should be further understood by those skilled in the art that although the foregoing description has been made on embodiments of the invention, the invention is not limited thereto and various changes and modifications may be made without departing from the spirit of the invention and the scope of the appended claims.

1. An information recording method of recording data in a recording medium, comprising the steps of:
recording, in the recording medium, information in a space bit map format representing recorded and unrecorded areas assigned according to each recording unit of the areas in the recording medium; and
recording, when information corresponding to a position of recorded and unrecorded areas is updated, the information in a space bit map format again in the recording medium at predetermined timing.

2. A recording apparatus for recording data in a recording medium, comprising:
a pickup;
a signal processing circuit for executing signal processing to record data in the recording medium; and
an interface for conducting data input and output operations, wherein
the pickup reads, from the recording medium, information in a space bit map format representing recorded and unrecorded areas assigned according to each recording unit of the areas in the recording medium and then stores the information corresponding to a position of recorded and unrecorded areas in a nonvolatile memory.

3. A recording apparatus according to claim 2, wherein:
when the information in the space bit map format is updated, an update flag indicating an event of update of the information is set in the nonvolatile memory;
information corresponding to a position of recorded and unrecorded areas is recorded in the recording medium at predetermined timing; and
the update flag is reset when the information is completely recorded.

4. A recording apparatus for recording data in a recording medium, comprising:
a pickup;
a signal processing circuit for executing signal processing to record data in the recording medium; and
an interface for conducting data input and output operations, wherein:
the pickup reads, from the recording medium, information in a space bit map format representing recorded and unrecorded areas assigned according to each recording unit of the areas in the recording medium; and
when the information in the space bit map format is updated, an error data is caused at a particular position indicating an event of update of the information and is stored in the recording medium.

5. A recording apparatus according to claim 4, wherein the error data is caused at a particular position of the information in a space bit map format corresponding to a position of the recording and unrecorded areas of a second last generation in the recording medium.

6. An information recording method of recording data in a recording medium, comprising the steps of:
recording, in the recording medium, information to control recorded and unrecorded areas in areas in the recording medium;
recording, when the information representing recorded and unrecorded areas is updated, the information in the recording medium at predetermined timing; and
recording one of flags indicating respective types of the timing of the update in the recording medium.

7. A recording method according to claim 6, wherein:
each of the flags indicating respective types of the timing of the update is associated with a group of several points of timing; and
one of the flags is recorded in the recording medium, the flag thus recorded corresponding to a point of timing of the update.

8. A recording method according to claim 7, wherein:
the flags indicating respective types of the timing of the update are assigned at least to timing of an audiovisual device and timing of personal computer; and
one of the flags is recorded in the recording medium, the flag thus recorded corresponding to a point of timing of the update.

9. A recording apparatus for recording data in a recording medium, comprising:
a pickup;
a signal processing circuit for executing signal processing to record data in the recording medium; and
an interface for conducting data input and output operations, wherein:
the information representing recorded and unrecorded areas in areas in the recording medium is recorded in the recording medium;
when the information to control recorded and unrecorded areas is updated, the information is recorded in the recording medium at predetermined timing; and
one of flags indicating respective types of the timing of the update is recorded in the recording medium.

10. A recording apparatus according to claim 9, wherein:
each of the flags indicating respective types of the timing of the update is associated with a group of several points of timing; and
one of the flags is recorded in the recording medium, the flag thus recorded corresponding to a point of timing of the update.

11. A recording apparatus according to claim 10, wherein:
the flags indicating respective types of the timing of the update are assigned at least to timing of an audiovisual device and timing of personal computer; and
one of the flags is recorded in the recording medium, the flag thus recorded corresponding to a point of timing of the update.

12. A recording medium in which information to control recorded or unrecorded areas in recording areas is recorded, wherein:
when the information representing recorded and unrecorded areas is updated, the information is recorded in the recording medium at predetermined timing; and
one of flags indicating respective types of the timing of the update is recorded in the recording medium.

13. A recording medium according to claim 12, wherein:
each of the flags indicating respective types of the timing of the update is associated with a group of several points of timing; and
one of the flags is recorded in the recording medium, the flag thus recorded corresponding to a point of timing of the update.

14. A recording medium according to claim 13, wherein:
the flags indicating respective types of the timing of the update are assigned at least to timing of an audiovisual device and timing of personal computer; and
one of the flags is recorded in the recording medium, the flag thus recorded corresponding to a point of timing of the update.
